(19) United States
(12) Patent Application Publication
(10) Pub. No.: US 2006/0164865 A1
(43) Pub. Date: Jul. 27, 2006

(54) Lamp holder

(75) Inventors: Vaughan Lyall Bycroft, Surrey (GB); Steven Craig Olsen, London (GB); Michael-John Austin, Surrey (GB)

Correspondence Address: Clifford W. Browning, Suite 3700, 111 Monument Circle, Indianapolis, IN, 46204-5137, US

(73) Assignee: Jerrard Bros. plc

(21) Appl. No.: 11/090,610

(22) Filed: Mar. 25, 2005

(30) Foreign Application Priority Data
Jan. 25, 2005 (EP) 05250347.1

(51) Int. Cl. F21V 31/00; H01J 5/48

(52) U.S. Cl. 362/645; 362/267; 362/217

(57) ABSTRACT

A lamp holder is disclosed comprising a body (30) for receiving one end of a lamp (50), and a collar (20) which is arranged to fit over part of the lamp and to screw onto the body, the collar being provided with a seal (24) which is arranged so as to be urged against the lamp as the collar is screwed onto the body, wherein the seal (24) is formed integrally with the collar (20).

### BACKGROUND TO THE INVENTION

The present invention relates to a lamp holder, and in particular to a lamp holder in which a seal is provided between the holder and the lamp. The present invention has particular application in lamp holders for use in situations where it is desirable to prevent ingress of external matter, such as water or dust, into the lamp holder.

A known lamp holder for tubular lamps comprises a body for receiving one end of the lamp, and a collar which fits over part of the lamp and which screws onto the body in order to attach the lamp to the holder. An annular seal is contained within the collar, and the collar is provided with an internal ramp towards the lamp in the region of the seal. As the collar is tightened onto the body, the annular seal is forced along the ramp, and tightens around the lamp so as to grip the lamp and provide a seal.

In the known lamp holder described above the seal is moveable with respect to the collar, so that the seal can move down the ramp and grip the lamp.

A problem in the known lamp holder is that seal may be drawn out of position as the lamp is pushed into the holder. Another problem in the known lamp holder is that the seal could accidentally be left out of the collar, or put into the collar in reverse.

### SUMMARY OF THE INVENTION

According to one aspect of the present invention there is provided a lamp holder comprising a body for receiving one end of a lamp, and a collar which is arranged to fit over part of the lamp and to fit onto the body, the collar being provided with a seal which is arranged so as to be urged against the lamp as the collar is fitted onto the body, wherein the seal is formed integrally with the collar.

By arranging the seal to be formed integrally with the collar, a good seal can be achieved between the lamp holder and the lamp, and at the same time problems associated with mis-location of the seal may be avoided.

By “integrally” it is preferably meant that the seal and the collar form a single piece. The seal and collar may be fixed orjoined together, or they may be made as a single piece. The seal and collar may be made from different material, or from the same material.

Preferably the seal is bonded to the collar, in order to ensure that the seal is securely attached to the collar. The bonding may be physical, thermal or chemical bonding. For example, the seal may be made from a bonding grade material, and the material itself may form the bond between the seal and the collar. This may avoid the need to provide separate means for fixing the seal to the collar. However, in alternative embodiments, the seal may be adhered to the collar using a separate adhesive, or it may be physically held by the collar such that, in normal use, at least part of the seal is securely attached to the collar.

In a preferred embodiment of the invention the seal is formed by injection molding. This may provide a convenient way of forming the seal, and at the same time bonding the seal to the collar. Suitable materials for injection molding include thermoplastic elastomers (TPEs), and thus the seal may comprise a thermoplastic elastomer, preferably of bonding grade. For example, the thermoplastic elastomer may be TPE-E, TPE-V, TPE-U, TPE-S, TPE-A, TPE-O, or any other suitable type.

Alternatively the seal may be formed from any other suitable material, such as silicone, rubber or flexible polymers.

The collar itself may be made from any material that gives sufficient rigidity for the collar to be screwed onto the body. For example, the collar may be made from a rigid or semi-rigid polymer. Where the seal is formed by injection molding of a bonding grade material, the collar preferably comprises a material which provides good adhesion for the seal. Suitable materials in this respect include polycarbonates (PCs), polymers, copolymers such as ABS (acrylonitrile butadiene styrene), or mixtures such as PC/ABS, although other materials could be used.

The body may be made from any material that gives sufficient rigidity for the collar to be screwed onto the body. However some degree of flexibility may be desirable to provide flexibility for a cable joint, and thus the body may be made from a semi-rigid material. A suitable material for the body is PVC, although of course other materials could be used instead.

The body may be arranged to press against the seal as the collar is fitted on to the body, so as to urge the seal against the lamp. In this way the seal can be made to pinch the lamp, which can ensure that good contact is made between the seal and the lamp. Furthermore, arranging the body to press against the seal can facilitate an arrangement in which the seal is formed integrally with the collar.

Preferably the body is provided with a ramp for urging the seal against the lamp as the collar is fitted onto the body. It will be appreciated that this arrangement is in contrast to the known lamp holder, in which the collar is provided with a ramp. Providing a ramp on the body facilitates an arrangement in which the seal is formed integrally with the collar.

Preferably part of the seal is deformable in the direction of the lamp. The lamp holder may then be arranged such that part of the seal is deformed in the direction of the lamp as the collar is fitted on to the body, thereby to provide a seal with the lamp. For example, if the body has a ramp, then the ramp may deform part of the seal towards the lamp as the collar is screwed on to the body. The deformable part of the seal may be annular, and may be an interior part.

According to another aspect of the present invention there is provided a lamp holder comprising a body for receiving one end of a lamp, and a collar which is arranged to fit over the lamp and to fit onto the body, the collar being provided with a seal, wherein the body comprises a ramp which is arranged to urge the seal against the lamp as the collar is fitted onto the body.

Preferably the seal is arranged such that, when the collar has been fitted onto the body, the seal provides a seal between the body and the lamp. This arrangement is particularly advantageous, since it may provide a three way seal between the lamp, the collar and the body. Thus this arrangement may prevent ingress of external matter to the interior of the body either through the join between the collar and the lamp, or through the threads of the screw between the collar and the body.

The body preferably comprises at least one electrical contact for supplying electricity to the lamp. The body may have two (or more) electrical contacts for supplying electricity to the lamp. The body may be joined to an electrical cable. The body may be bonded to the electrical cable.

The body and the collar may have respective threads for screwing the collar onto the body. For example, the body may have a thread on its outside surface and the collar may have a thread on its inside surface, for screwing the collar onto the body, or the body may have a thread on its inside surface and the collar may have a thread on its outside surface. Alternatively some other mechanism may be provided for fitting the collar to the body, such as a bayonet fitting, a ratchet, a cam, a lever or any other type of fixing mechanism.

Since the collar may need to be screwed on to the lamp holder body, it may be desirable to provide the collar with a grip to assist the operator with tightening the collar. In a preferred embodiment of the invention, the seal and the grip are made from the same material, and are formed at the same time. For example, the seal may wrap around or pass through the collar, so as to form the grip. Thus the grip and the seal may be formed from one continuous part. This may allow the lamp holder to be more easily manufactured than if a separate grip were provided. For example, the seal and the grip may be formed at the same time by injection molding.

Arranging the seal to wrap around or pass through the collar also provides the advantage that a greater surface area is present between the collar and the seal, which may allow the seal to be connected more securely to the collar. Thus the seal may wrap around or pass through or into the collar even if a grip is not provided. For example, the collar may comprise a notch into which the part of the seal is fitted.

According to another aspect of the present invention there is provided a lamp holder comprising a body for receiving one end of a lamp, and a collar which is arranged to fit over the lamp and to screw onto the body, the collar being provided with a seal and a grip, wherein the seal and the grip are formed from one continuous part.

The lamp may be a tubular lamp, such as a florescent lamp, in which case the collar may be arranged to fit over part of the tube. Alternatively the lamp may be some other type of lamp such as a bulb lamp (light bulb).

In any of the above aspects the seal is preferably arranged such that, when the collar is fitted on to the body, the seal prevents or reduces ingress of external matter into the body. For example, the seal may be arranged to prevent the ingress of water, dust or other matter. The lamp holder may thus be water tight, or water proof, or splash proof, jet proof or dust protected or dust tight or any combination thereof. For example, the lamp holder may comply with standards IP64 (splash proof) and/or IP67 (watertight). The lamp holder may be suitable for use, for example, in damp environments such as aquatic tanks.

The lamp holder of the present invention may be arranged to prevent fumes or gases from entering the body. For example, certain gases or fumes (such as petrol fumes) may combust or explode in the presence of electrical contacts. The lamp holder may thus be suitable for use in environments where such gases or fumes may be encountered, such as petrol forecourts.

Corresponding method aspects of the invention are also provided. Thus, according to another aspect of the invention there is provided a method of manufacturing a lamp holder, the lamp holder comprising a body for reviewing one end of a lamp, and a collar which is arranged to fit over part of the lamp and to fit onto the body, the collar being provided with a seal which is arranged so as to be urged against the lamp as the collar is fitted onto the body, the method comprising forming the seal integrally with the collar.

Any of the apparatus features of the invention may also be provided as method features.

### BRIEF DESCRIPTION OF THE DRAWINGS

Preferred features of the present invention will now be described, purely by way of example, with reference to the accompanying drawings, in which:

FIG. 1 shows a cross section of a known lamp holder;

FIGS. 2, 3A and 3B show cross sections of a lamp holder according to an embodiment of the invention;

FIG. 4 shows a side view of a lamp holder according to an embodiment of the invention; and

FIG. 5 shows an end view of a lamp holder according to an embodiment of the invention.

### DETAILED DESCRIPTION OF EMBODIMENTS OF THE INVENTION

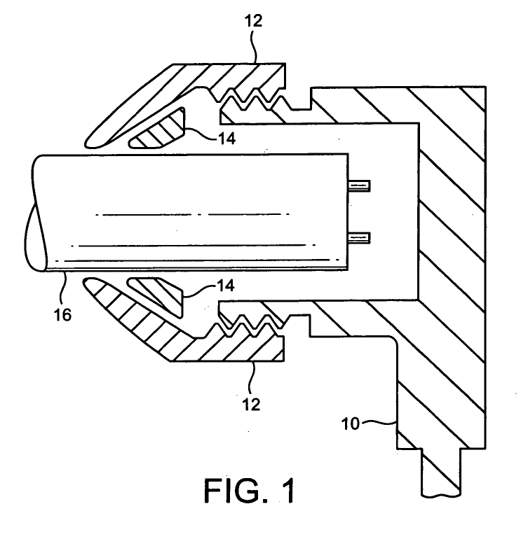

FIG. 1 shows a cross section of a known lamp holder. The lamp holder comprises a body 10, a collar 12 and a seal 14. In use, a lamp 16 is inserted into the collar 12, and the collar is screwed onto the body 10. The collar has a ramp which, as the collar is screwed onto the body, causes the seal to be pinched between the collar and the lamp, thereby providing a seal between the two.

In the known lamp holder the seal 14 may become dislocated which may affect the efficiency of the seal. In addition, it may be possible for external material such as fluids or dust to enter the interior of the body via the screw threads.

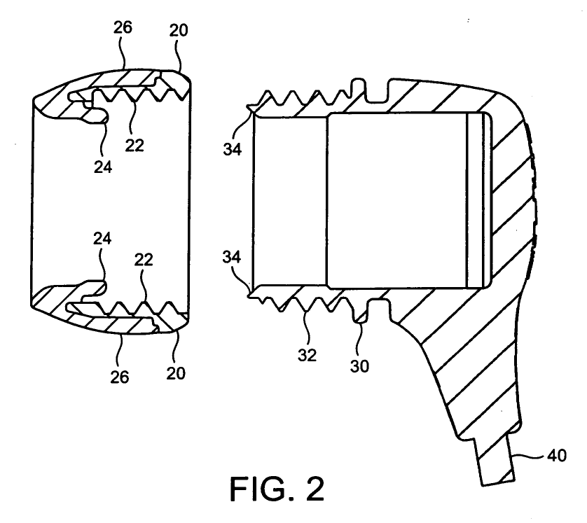

FIG. 2 shows a cross section of a lamp holder according to an embodiment of the invention. The lamp holder comprises a collar 20 and a body 30. The collar is of dimensions that allow it to be loosely fit over part of a lamp (not shown) which it is desired to hold. The body 30 contains electrical contacts for supplying electricity to the lamp. An electrical cable 40 is provided for connection to a source of electricity.

The collar 20 is provided with thread 22, and the body 30 is provided with thread 32, which are arranged to engage with each other as the collar is screwed onto the body. In FIG. 2 the collar and the body are shown before the collar has been screwed onto the body.

The collar 20 is provided with a seal 24, which in this embodiment is a ring of flexible material which is located inside the collar 20. The body 30 is provided with a ramp 34 which is arranged to press against the seal 24 as the collar is screwed onto the body.

FIGS. 3A and 3B show a cross section of the lamp holder once the collar has been screwed onto the body. In FIG. 3A the lamp holder is shown holding a lamp 50.

As can be seen from FIGS. 3A and 3B, as the collar 20 screws onto the body 30, the ramp 34 presses against the seal 24, and causes the seal 24 to deform inwards towards the interior of the lamp holder, and thereby to grip the lamp 50. In this position the seal 24 provides a three way seal between the lamp 50, the collar 20 and the body 30. Thus the seal 24 acts to prevent external matter, such as water or dust, from entering the interior of the lamp holder body either via the join between the lamp and the collar, or via the screw threads.

In FIGS. 2 and 3 the seal 24 wraps around the outside of the collar 20 in order to provide a grip 26. The grip 26 may have ridges in order to assist an operator with tightening of the collar on the body.

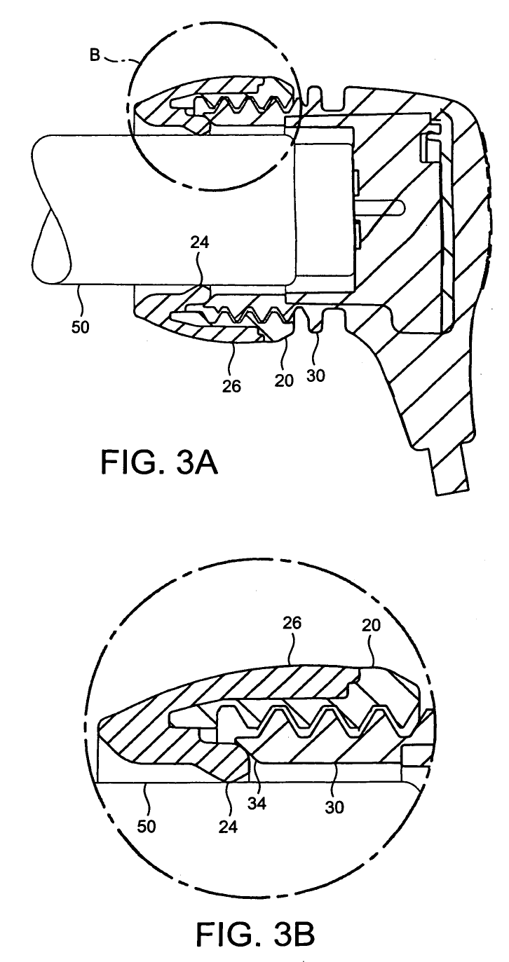

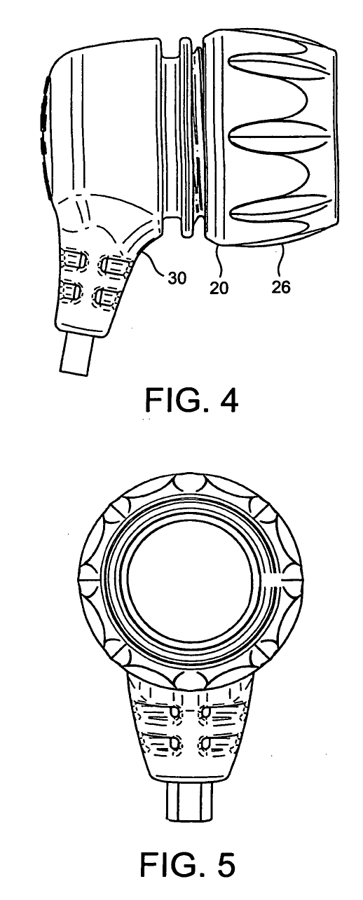

FIGS. 4 and 5 show side and front views respectively of the lamp holder with the collar screwed onto the body. As can be seen from FIG. 4 in particular, the grip consists of a series of ridges which aid an operator in gripping the collar.

In the present embodiment the seal and grip are made by injection molding a thermoplastic elastomer (TPE) onto the collar. Thermoplastic elastomers are well known and widely available. The TPE is bonding grade, so that the seal and grip bond to the collar as part of the molding process. The collar is made from a rigid polymer which provides a good adhesive surface for the TPE. This ensures that the seal is securely bonded to the collar, so that in normal use it will not become detached. The fact that the seal wraps around the collar to form the grip also helps to secure the seal to the collar, since a greater surface area is present between the two than would otherwise be the case.

In the present embodiment the body is made from PVC.

Although the present invention has been described with reference to a specific embodiment, it will be appreciated that alternative embodiments are also possible. For example, the seal need not wrap around or through the collar, and thus need not form a grip. Furthermore the lamp holder may be suitable for lamps other than tubular lamps, such a bulb lamps or any other types of lamps. Materials other than those described above could be used to form the collar, body or seal.

What is claimed is:

1. A lamp holder comprising a body for receiving one end of a lamp, and a collar which is arranged to fit over part of the lamp and to screw onto the body, the collar being provided with a seal which is arranged so as to be urged against the lamp as the collar is fitted onto the body, wherein the seal is formed integrally with the collar.

2. A lamp holder according to claim 1 wherein the seal is bonded to the collar.

3. A lamp holder according to claim 2 wherein the seal is made from a bonding grade material, and the material itself forms a bond between the seal and the collar.

4. A lamp holder according to claim 1 wherein the seal is adhered to the collar with an adhesive.

5. A lamp holder according to claim 1 wherein the seal is physically held by the collar such that, in normal use, at least part of the seal is securely attached to the collar.

6. A lamp holder according to claim 1 wherein the seal is formed by injection molding.

7. A lamp holder according to claim 1 wherein the seal comprises a thermoplastic elastomer.

8. A lamp holder according to claim 1, wherein the body is arranged to press against the seal as the collar is fitted on to the body, so as to urge the seal against the lamp.

9. A lamp holder according to claim 1, wherein the body is provided with a ramp for urging the seal against the lamp as the collar is fitted on to the body.

10. A lamp holder according to claim 1, wherein the lamp holder is arranged such that part of the seal is deformed in the direction of the lamp as the collar is fitted on to the body.

11. A lamp holder according to claim 10, wherein the body is provided with a ramp which is arranged to deform part of the seal towards the lamp as the collar is fitted on to the body.

12. A lamp holder according to claim 1 wherein, when the collar has been fitted onto the body, the seal provides a seal between the body and the lamp.

13. A lamp holder according to claim 1 wherein the body comprises at least one electrical contact for supplying electricity to the lamp.

14. A lamp holder according to claim 1 wherein the body and the collar have respective threads for screwing the collar onto the body.

15. A lamp holder according to claim 1 wherein the seal wraps around or passes through the collar.

16. A lamp holder according to claim 1 wherein the collar includes a grip, and the grip and the seal are formed from one continuous part.

17. A lamp holder according to claim 1 wherein, when the collar is fitted to the body, the seal prevents or reduces ingress of external matter or gases or fumes into the body.

18. A lamp holder comprising a body for receiving one end of a lamp, and a collar which is arranged to fit over the lamp and to fit onto the body, the collar being provided with a seal, wherein the body comprises a ramp which is arranged to urge the seal against the lamp as the collar is fitted onto the body.

19. A lamp holder according to claim 18, wherein the ramp is arranged to deform part of the seal towards the lamp as the collar is fitted on to the body.

20. A lamp holder according to claim 18 wherein, when the collar has been fitted onto the body, the seal provides a seal between the body and the lamp.

21. A lamp holder according to claim 18 wherein the body and the collar have respective threads for screwing the collar onto the body.

22. A method of manufacturing a lamp holder, the lamp holder comprising a body for receiving one end of a lamp and a collar which is arranged to fit over part of the lamp and to fit onto the body, the collar being provided with a seal which is arranged so as to be urged against the lamp as the collar is fitted onto the body, the method comprising forming the seal integrally with the collar.
